(19) United States
(12) Patent Application Publication
(10) Pub. No.: US 2025/0111531 A1
(43) Pub. Date: Apr. 3, 2025

(54) IMAGE PROCESSING APPARATUS, IMAGE PROCESSING METHOD, AND NON-TRANSITORY COMPUTER READABLE MEDIUM

(71) Applicant: NEC Corporation, Tokyo (JP)

(72) Inventors: Kazumine OGURA, Tokyo (JP); Kyota HIGA, Tokyo (JP); Kazuya INABA, Tokyo (JP)

(73) Assignee: NEC Corporation, Tokyo (JP)

(21) Appl. No.: 18/771,114

(22) Filed: Jul. 12, 2024

(30) Foreign Application Priority Data
Sep. 28, 2023 (JP) 2023-168523

(51) Int. Cl. G06T 7/70; G06T 17/00; H04N 5/74

(52) U.S. Cl. CPC G06T 7/70; G06T 17/00; H04N 5/74

(57) ABSTRACT

An image processing apparatus includes: a posture estimation unit configured to estimate a position and a posture of a camera when the camera has captured each of at least two images including the same phenomena based on the at least two images and three-dimensional data of a structure; an area selection unit configured to select an area of the phenomenon in each of the at least two images; a three-dimensional position specification unit configured to specify a position of each of the phenomena in a coordinate system of the three-dimensional data; and a projection unit configured to generate a projection image by projecting three-dimensional data including the specified position of each of the phenomena and compositing the phenomena included in the images in such a manner that the phenomena for the images are distinguishable from each other.

### INCORPORATION BY REFERENCE

This application is based upon and claims the benefit of priority from Japanese patent application No. 2023-168523, filed on Sep. 28, 2023, the disclosure of which is incorporated herein in its entirety by reference.

### TECHNICAL FIELD

The present disclosure relates to an image processing apparatus, an image processing method, and a non-transitory computer readable medium.

### BACKGROUND ART

As related art, Japanese Unexamined Patent Application Publication No. 2017-168077 discloses an image processing apparatus used for the inspection of a bridge and other structures. In Japanese Unexamined Patent Application Publication No. 2017-168077, an inspector captures an image of a crack in a structure from a plurality of observation points in order to observe or inspect the condition of the crack in the structure. The inspector inputs a plurality of the captured two-dimensional images into the image processing apparatus.

The image processing apparatus generates a three-dimensional mesh that approximates at least a part of the structure. The image processing apparatus also generates a two-dimensional development view obtained by deploying the three-dimensional mesh on a two-dimensional plane. The two-dimensional development view is a diagram obtained by transforming each sub-plane that the three-dimensional mesh includes such that the sub-plane is projected orthographically. The image processing apparatus performs coordinate transformation on the plurality of the captured images with regard to the two-dimensional development view and combines the plurality of the images subjected to the coordinate transformation with each other based on coordinate values, thereby generating a panoramic image.

In Japanese Unexamined Patent Application Publication No. 2017-168077, a user can refer to one of a plurality of two-dimensional images and input coordinate values of an object such as a crack and text indicating an annotation for the object. In Japanese Unexamined Patent Application Publication No. 2017-168077, the stored annotation can be superimposed on another image having panoramic coordinates and displayed.

In Japanese Unexamined Patent Application Publication No. 2017-168077, the image processing apparatus panoramically combines a plurality of images captured during the same period. In this case, a user such as an inspector can check a crack occurred in a bridge by using a plurality of images. However, in Japanese Unexamined Patent Application Publication No. 2017-168077, it is not considered to confirm whether the damage such as a crack has not changed in units such as months or years. In Japanese Unexamined Patent Application Publication No. 2017-168077, since only a plurality of images are panoramically combined with each other, a user cannot easily determine whether there has been a change in the crack, the flaw, and the like occurred between the images.

### SUMMARY

In view of the above circumstances, one of the objects of the present disclosure is to provide an image processing apparatus, an image processing method, and a non-transitory computer readable medium by which a user can easily determine whether there has been a change in regard to the phenomenon, such as a crack or damage, that has occurred in a structure.

An image processing apparatus according to a first example aspect of the present disclosure includes: a posture estimation unit configured to estimate a position and a posture of a camera when the camera has captured each of at least two images including phenomena the same as each other based on the at least two images and three-dimensional data of a structure; an area selection unit configured to select an area of the phenomenon in each of the at least two images; a three-dimensional position specification unit configured to specify a position of each of the phenomena in a coordinate system of the three-dimensional data based on the estimated position and posture of the camera and the area selected in each of the at least two images; and a projection unit configured to generate a projection image by projecting three-dimensional data including the specified position of each of the phenomena and compositing the phenomena included in the images in such a manner that the phenomena for the images are distinguishable from each other.

An image processing method according to a second example aspect of the present disclosure includes: estimating a position and a posture of a camera when the camera has captured each of at least two images including phenomena the same as each other based on the at least two images and three-dimensional data of a structure; selecting an area of the phenomenon in each of the at least two images; specifying a position of each of the phenomena in a coordinate system of the three-dimensional data based on the estimated position and posture of the camera and the area selected in each of the at least two images; and generating a projection image by projecting three-dimensional data including the specified position of each of the phenomena and compositing the phenomena included in the images in such a manner that the phenomena for the images are distinguishable from each other.

A non-transitory computer readable medium according to a third example aspect of the present disclosure stores a program for causing a computer to execute processing including: estimating a position and a posture of a camera when the camera has captured each of at least two images including phenomena the same as each other based on the at least two images and three-dimensional data of a structure; selecting an area of the phenomenon in each of the at least two images; specifying a position of each of the phenomena in a coordinate system of the three-dimensional data based on the estimated position and posture of the camera and the area selected in each of the at least two images; and generating a projection image by projecting three-dimensional data including the specified position of each of the phenomena and compositing the phenomena included in the images in such a manner that the phenomena for the images are distinguishable from each other.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing an example of a schematic configuration of an image processing apparatus according to the present disclosure;

FIG. 2 is a block diagram showing an example of a schematic configuration of a first image processing apparatus according to the present disclosure;

FIG. 3 is a diagram showing an example of an image acquired by an image input unit;

FIG. 4 is a diagram showing an example of another image acquired by the image input unit;

FIG. 5 is a diagram schematically showing a phenomenon in which the position thereof is specified in three-dimensional data;

FIG. 6 is a diagram schematically showing a phenomenon position specified on the three-dimensional data and a projection range;

FIG. 7 is a diagram showing an example of a projection image to be displayed;

FIG. 8 is a flowchart showing an example of an operation procedure in the image processing apparatus;

FIG. 9 is a block diagram showing an example of a schematic configuration of a second image processing apparatus according to the present disclosure;

FIG. 10 is a diagram showing an example of information stored in a phenomenon DB; and

FIG. 11 is a block diagram showing an example of a configuration of a computer apparatus.

### EXAMPLE EMBODIMENT

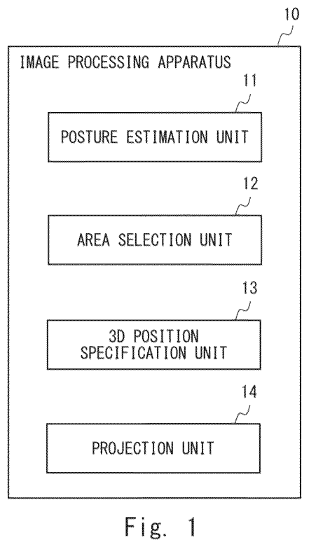

Prior to describing example embodiments of the present disclosure, an outline of the present disclosure will be described. FIG. 1 shows an example of a schematic configuration of an image processing apparatus according to the present disclosure. An image processing apparatus 10 includes a posture estimation unit 11, an area selection unit 12, a three-dimensional position specification unit 13, and a projection unit 14.

The posture estimation unit 11 estimates a position and a posture of a camera when the camera captures an image of each of at least two images including phenomena the same as each other based on the at least two images and three-dimensional data of a structure. The area selection unit 12 selects an area of the phenomenon in each of the at least two images. The three-dimensional position specification unit 13 specifies a position of each of the phenomena in a coordinate system of the three-dimensional data based on the estimated position and posture of the camera and the area selected in each of the at least two images. The projection unit 14 generates a projection image by projecting three-dimensional data including the specified position of each of the phenomena and compositing the phenomena included in the images in such a manner that the phenomena for the images are distinguishable from each other.

In the image processing apparatus according to the present disclosure, the posture estimation unit 11 estimates a position and a posture of a camera when the camera captures an image. The three-dimensional position specification unit 13 specifies a position of each of the phenomena in a coordinate system of the three-dimensional data based on the estimated position and posture of the camera and an area of the phenomenon selected in each image by the area selection unit 12. The projection unit 14 generates a projection image onto which the position of the phenomenon on the three-dimensional data is projected and in which the phenomena included in the images are composited in such a manner that the phenomena for the images are distinguishable from each other. In the present disclosure, a phenomenon such as a crack included in each of a plurality of images is projected onto the projection image. Therefore, by observing the projection image, a user can easily determine whether there has been a change in regard to the phenomenon, such as a crack or damage, that has occurred in a structure.

The example embodiments of the present disclosure will be described hereinafter in detail. Note that, for the clarification of the description, the following descriptions and the drawings are partially omitted and simplified as appropriate. Further, the same elements and similar elements are denoted by the same reference symbols throughout the drawings, and redundant descriptions are omitted as necessary.

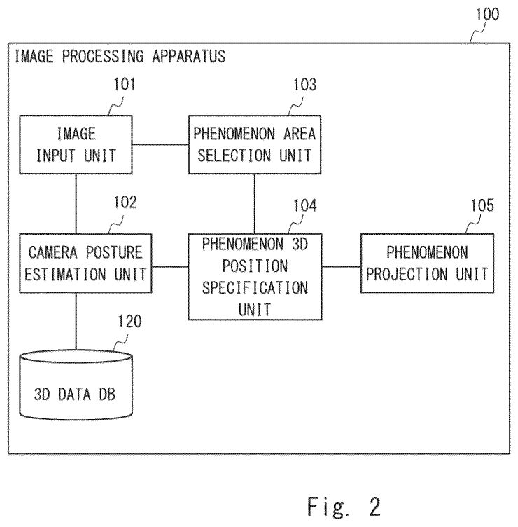

A first example embodiment will be described. FIG. 2 shows an example of a schematic configuration of a first image processing apparatus according to the present disclosure. An image processing apparatus 100 shown in FIG. 2 includes an image input unit 101, a camera posture estimation unit 102, a phenomenon area selection unit 103, a phenomenon three dimensions (3D) position specification unit 104, a phenomenon projection unit 105, and a 3D data database (DB) 120. In this example embodiment, the image processing apparatus 100 can be used to inspect a structure such as a bridge. The inspection may be performed periodically, for example, every few months or every few years. Alternatively, the inspection may be performed irregularly.

Note that the image processing apparatus 100, for example, may be physically configured as an apparatus including one or more processors and one or more memories. At least some of the functions of the respective units included in the image processing apparatus 100 may be implemented by the one or more processors executing processing in accordance with instructions loaded from the one or more memories.

The image input unit 101 acquires a plurality of images. In this example embodiment, the image input unit 101 acquires an image obtained by capturing a structure such as a bridge. The image input unit 101 acquires, for example, one or more images captured during a first period and one or more images captured during a second period. For example, an inspector of the structure captures an image of a phenomenon or a deformation, such as a crack or damage, that has occurred in the structure, and inputs the captured image into the image input unit 101. The images acquired by the image input unit 101 include two or more images captured during periods or at times different from each other and including phenomena the same as each other.

The 3D data DB 120 stores three-dimensional data of a structure. The three-dimensional data is also referred to as three-dimensional point cloud data. The three-dimensional data may be created using a range sensor, such as Light Detection And Ranging (LiDAR). The camera posture estimation unit 102 estimates a position and a posture of a camera when the camera has captured each of at least two images, which images include phenomena the same as each other and captured during different periods, based on each of the images and the three-dimensional data of the structure. In other words, the camera posture estimation unit 102 estimates at which position and in what posture the camera has captured each of the images. The camera posture estimation unit 102 corresponds to the posture estimation unit 11 shown in FIG. 1.

The phenomenon area selection unit 103 selects a phenomenon area, i.e., an area of a phenomenon, in each of the plurality of images acquired by the image input unit 101. The phenomenon area selection unit 103 may, for example, perform image processing on each of the images, automatically recognize a place where a crack or damage has occurred in the structure, and select the place where a crack or damage has occurred as a phenomenon area. The phenomenon area selection unit 103 may recognize a place where a crack or damage has occurred by using, for example, an artificial intelligence (AI) engine. The phenomenon area selection unit 103 corresponds to the area selection unit 12 shown in FIG. 1.

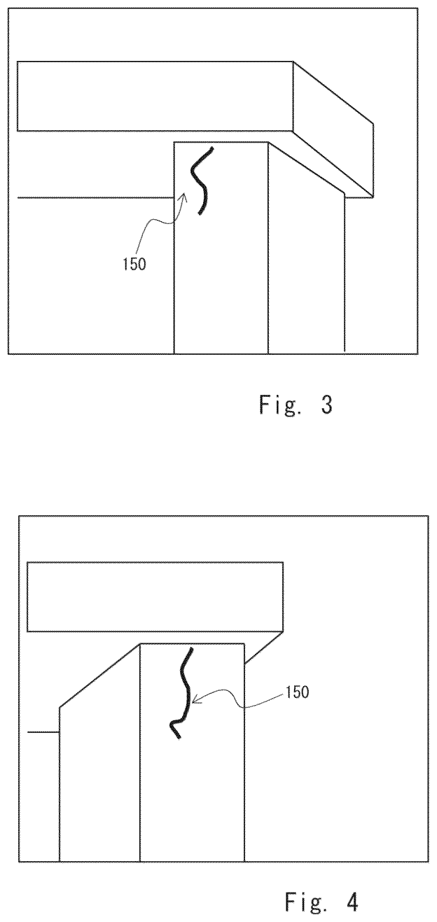

FIG. 3 shows an example of an image acquired by the image input unit 101. It is assumed that the image shown in FIG. 3 is, for example, an image obtained by capturing a structure during the first period. This image includes a deformation 150 such as a crack. The phenomenon area selection unit 103 selects an area of the deformation 150 from the image by using, for example, an AI engine. Further, the camera posture estimation unit 102 estimates a position and a posture of the camera when the camera has captured the image shown in FIG. 3. The camera posture estimation unit 102, for example, matches three-dimensional data of the structure stored in the 3D data DB 120 with each area of the structure in the image, thereby estimating from which position and in what posture the camera has captured the image.

FIG. 4 shows an example of another image acquired by the image input unit 101. It is assumed that the image shown in FIG. 4 is an image obtained by capturing a structure during the second period, for example, one year after the first period. The image includes the same crack as the deformation 150 included in the image shown in FIG. 3. However, the camera has captured the image shown in FIG. 4 at a position and in a posture different from those when the camera has captured the image shown in FIG. 3. The phenomenon area selection unit 103 selects an area of the deformation 150 from the image by using, for example, an AI engine. Further, the camera posture estimation unit 102 estimates a position and a posture of the camera when the camera has captured the image shown in FIG. 4. A user, such as an inspector, may observe each of the image shown in FIG. 3 and the image shown in FIG. 4, manually recognize a place where a crack or damage has occurred, and manually set an area including the phenomenon in the phenomenon area selection unit 103.

Referring back to FIG. 2, the phenomenon 3D position specification unit 104 specifies a position of each of the phenomena in a coordinate system of the three-dimensional data, that is, a phenomenon position, based on the phenomenon area selected by the phenomenon area selection unit 103 and the position and the posture of the camera estimated by the camera posture estimation unit 102. In the following description, for the sake of convenience, one of a plurality of images including phenomena the same as each other is referred to as a first image, and another one of them is referred to as a second image. The phenomenon 3D position specification unit 104 specifies each of phenomenon positions in the coordinate system of three-dimensional data by, for example, mapping the phenomenon area selected in the first image to the three-dimensional data based on the position and the posture of the camera estimated for the first image. Further, the phenomenon 3D position specification unit 104 specifies each of phenomenon positions in the coordinate system of three-dimensional data by mapping the phenomenon area selected in the second image to the three-dimensional data based on the position and the posture of the camera estimated for the second image. The phenomenon 3D position specification unit 104 corresponds to the three-dimensional position specification unit 13 shown in FIG. 1.

The phenomenon projection unit 105 generates a projection image by projecting three-dimensional data including the specified phenomenon position. The phenomenon projection unit 105 may project three-dimensional data by parallel projection. However, the present disclosure is not limited thereto. For example, in the projection image, the phenomenon projection unit 105 overlaps the phenomena included in the plurality of respective images on each other in a chronological order or in a reverse chronological order.

In this example embodiment, the phenomenon projection unit 105 composites the phenomena included in the plurality of respective images in the projection image in such a manner that they are distinguishable from each other. For example, the phenomenon projection unit 105 assigns display colors different from each other to the phenomena included in the plurality of respective images. Alternatively, the phenomenon projection unit 105 may overlap the phenomena included in the plurality of respective images on each other in a state in which they are slightly shifted. The phenomenon projection unit 105 may set a different transmittance for each of the phenomena included in the plurality of respective images. The phenomenon projection unit 105 corresponds to the projection unit 14 shown in FIG. 1.

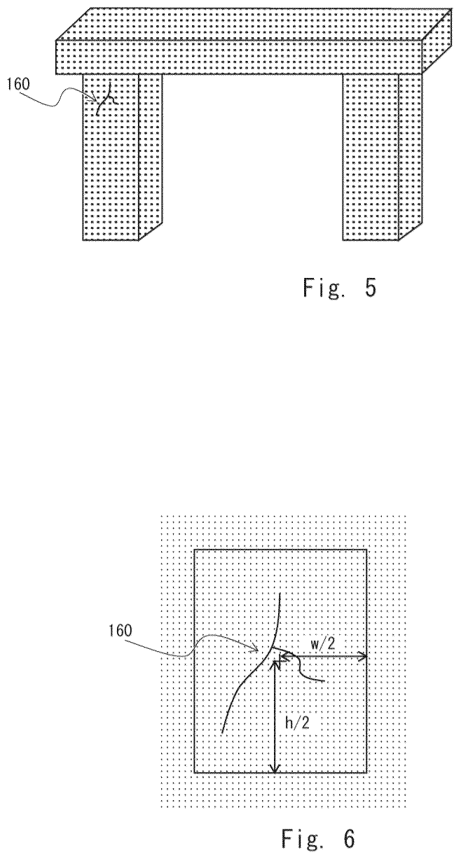

FIG. 5 schematically shows a phenomenon in which the position thereof is specified in three-dimensional data. In FIG. 5, each point on the surface of the structure indicates a data point of three-dimensional data of the structure stored in the 3D data DB 120. The phenomenon 3D position specification unit 104 specifies a position of the phenomenon area selected in a two-dimensional camera image in the coordinate system of three-dimensional data based on the three-dimensional data of the structure and the estimated position and posture of the camera. The phenomenon position in the coordinate system of the three-dimensional data specified by the phenomenon 3D position specification unit 104 corresponds to the three-dimensional data of the phenomenon.

The phenomenon projection unit 105 determines a surface to which the phenomenon belongs, that is, a surface in which the phenomenon has occurred, as a projection surface based on the specified position of the phenomenon in the coordinate system of the three-dimensional data. For example, in the three-dimensional data, the phenomenon projection unit 105 calculates a curvature of the surface near the phenomenon from the area near a phenomenon 160, for example, the normal of each point of the three-dimensional data in a predetermined range including the phenomenon 160. In the three-dimensional data, the phenomenon projection unit 105 determines, as a projection surface, a surface having a curvature equal to the calculated curvature in the area near an area of a predetermined range, that is, the area continuously formed with an area of a predetermined range. When a phenomenon has occurred, for example, in a columnar bridge pier, the phenomenon projection unit 105 determines a surface of the column as a projection surface.

FIG. 6 schematically shows a phenomenon position specified on the three-dimensional data and a projection range. The phenomenon projection unit 105 determines a projection range shown in the projection image in the determined projection surface. The phenomenon projection unit 105 determines, for example, a range shown by a rectangle of a predetermined size that includes the center position of the phenomenon in the three-dimensional coordinate system, that is, the center position of the phenomenon in the coordinate system of the three-dimensional data, as the projection range. For example, the phenomenon projection unit 105 sets the center position of the phenomenon 160 as a projection center, and determines a range represented by a rectangle of a width w and a height h as the projection range. The width w and the height h may vary in accordance with the magnitude of the phenomenon. The phenomenon projection unit 105 generates, for example, an image of the phenomenon 160 viewed from the front of the projection surface as a projection image.

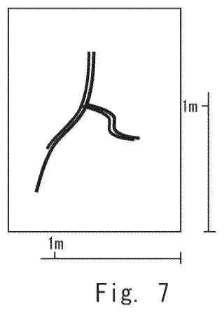

FIG. 7 shows an example of a projection image to be displayed. The phenomenon projection unit 105 displays the generated projection image on a display screen. In the projection image, the phenomenon projection unit 105 overlaps the phenomenon area selected in the first image and the phenomenon area selected in the second image on each other while shifting their positions. At this time, the phenomenon projection unit 105 successively superimposes the phenomenon selected in the first image and the phenomenon selected in the second image on the projection image based on the period or the time the image has been captured. For example, the phenomenon projection unit 105 superimposes the phenomenon selected in the first image and the phenomenon selected in the second image on the projection image in a chronological order of the respective dates on which the first and the second images have been captured. The phenomenon projection unit 105 assigns display colors different from each other to the phenomenon selected in the first image and the phenomenon selected in the second image in the projection image. In this case, by observing the projection image, a user can determine whether or not the phenomenon has changed during the period of time between the time at which the first image has been captured and the time at which the second image has been captured, for example, whether or not a crack has become more extensive. The phenomenon projection unit 105 displays a scale symbol indicating a scale in the projection image. A user can know the actual size of a crack or the like by checking the scale symbol.

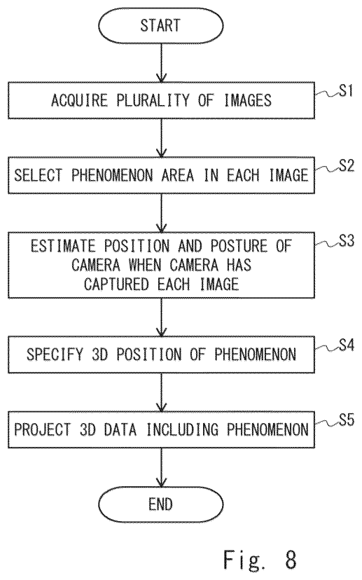

An operation procedure will be described. FIG. 8 shows an example of the operation procedure in the image processing apparatus 100. The operation procedure of the image processing apparatus 100 corresponds to an image processing method. The image input unit 101 acquires a plurality of images (Step S1). In Step S1, the image input unit 101 acquires, for example, a first image captured during a first period and a second image captured during a second period. The first image and the second image include phenomena the same as each other, such as cracks. The image input unit 101 may acquire three or more images captured during three or more periods, the images including phenomena the same as each other.

The phenomenon area selection unit 103 selects a phenomenon area in each of a plurality of images acquired by the image input unit 101 (Step S2). The camera posture estimation unit 102 estimates a position and a posture of the camera when the camera has captured each of the images based on each of the images and three-dimensional data of a structure stored in the 3D data DB 120 (Step S3). In Step S3, the camera posture estimation unit 102 estimates a position and a posture of the camera when the camera has captured each of the images in a coordinate system of the three-dimensional data. Either Step S2 or Step S3 may be performed first. Alternatively, Step S2 and Step S3 may be performed in parallel.

The phenomenon 3D position specification unit 104 specifies a three-dimensional position of each phenomenon, that is, a phenomenon position in a coordinate system of the three-dimensional data, based on the phenomenon area selected in Step S2 and the position and the posture of the camera estimated in Step S3 (Step S4). In Step S4, the phenomenon 3D position specification unit 104 specifies a position of the phenomenon area selected in the first image in the coordinate system of the three-dimensional data. Further, in Step S4, the phenomenon 3D position specification unit 104 specifies a position of the phenomenon area selected in the second image in the coordinate system of the three-dimensional data.

The phenomenon projection unit 105 generates a projection image by projecting the three-dimensional data including the phenomenon position specified in Step S4 (Step S5). In Step S5, in the projection image, the phenomenon projection unit 105 composites the phenomena included in the plurality of respective images in such a manner that they are distinguishable from each other. For example, the phenomenon projection unit 105 assigns display colors different from each other to the phenomena included in the plurality of respective images. The phenomenon projection unit 105 displays the generated projection image on a display screen.

In this example embodiment, the camera posture estimation unit 102 estimates a position and a posture of the camera when the camera has captured each of a plurality of images including phenomena the same as each other based on each of the images and three-dimensional data of a structure. The phenomenon area selection unit 103 selects a phenomenon area in each of the plurality of images. The phenomenon 3D position specification unit 104 specifies a three-dimensional position of each of the phenomena based on the phenomenon area selected in each of the images and the position and the posture of the camera estimated for each of the images. In this example embodiment, the image processing apparatus 100 estimates a position and a posture of the camera when the camera has captured the image, and specifies a position of each of the phenomena in the coordinate system of the three-dimensional data by using a result of the estimation. In this way, the image processing apparatus 100 can map the phenomena included in a plurality of images which the camera has captured at different positions and in different postures to the same three-dimensional position.

In this example embodiment, the phenomenon projection unit 105 generates a projection image by projecting three-dimensional data including the phenomenon in which the position thereof is specified in a coordinate system of three-dimensional data by the phenomenon 3D position specification unit 104. In other words, the phenomenon projection unit 105 generates a projection image in which each of the phenomena on three-dimensional data is visualized. In the projection image, the phenomenon projection unit 105 composites the phenomena included in the plurality of respective images in such a manner that they are distinguishable from each other. By doing so, the image processing apparatus according to this example embodiment can display in one projection image the phenomena included in a plurality of images which the camera has captured at different positions so that they can be compared with each other. Therefore, by observing the projection image, a user can easily determine whether there has been a change in regard to the phenomenon, such as a crack or damage, that has occurred in the structure, for example, a change in regard to the phenomenon over time.

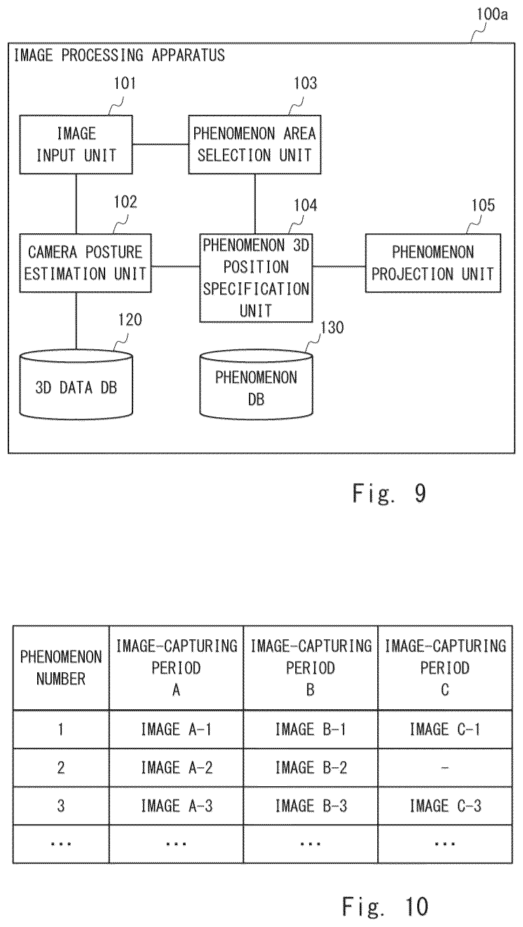

Next, a second example embodiment will be described. FIG. 9 shows an example of a schematic configuration of a second image processing apparatus according to the present disclosure. An image processing apparatus 100a shown in FIG. 9 includes a phenomenon DB 130 in addition to the components of the image processing apparatus 100 shown in FIG. 2. The phenomenon DB 130 stores, for each phenomenon and each period during which the image has been captured, information for identifying an image including the phenomenon, information about a phenomenon area in the image, and information about the estimated position and posture of a camera.

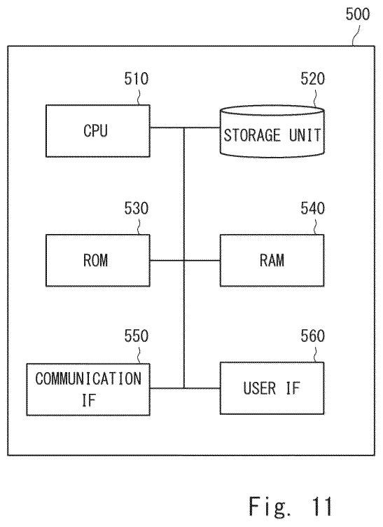

FIG. 10 shows an example of information stored in the phenomenon DB 130. In FIG. 10, the phenomenon number indicates information for identifying a phenomenon. In the example shown in FIG. 10, the phenomenon DB 130 stores information indicating which image each of the phenomena is included in during each of periods A, B, and C during which the image has been captured. For example, the phenomenon DB 130 stores information indicating that a phenomenon of the phenomenon number “1” is included in an image A-1 during the image-capturing period A, an image B-1 during the image-capturing period B, and an image C-1 during the image-capturing period C. For each image, the phenomenon DB 130 stores information about the phenomenon area selected by the phenomenon area selection unit 103 and information about the position and the posture of the camera estimated by the camera posture estimation unit 102. For each image, the phenomenon DB 130 may store the position of the phenomenon in the coordinate system of the three-dimensional data specified by the phenomenon 3D position specification unit 104.

For example, it is assumed that the image input unit 101 acquires the images A-1, B-1, and C-1, and an image D-1 captured during an image-capturing period D during which the image has been captured. The camera posture estimation unit 102 refers to the phenomenon DB 130 and checks whether or not information about the position and the posture of the camera estimated for each image is stored in the phenomenon DB 130. It is assumed that the phenomenon DB 130 stores information about the position and the posture of the camera estimated for each of the images A-1, B-1, and C-1. In this case, the camera posture estimation unit 102 acquires the information about the position and the posture of the camera estimated for each of the above images from the phenomenon DB 130. When information about the image D-1 is not stored in the phenomenon DB 130, the camera posture estimation unit 102 estimates a position and a posture of the camera regarding the image D-1.

Further, the phenomenon area selection unit 103 refers to the phenomenon DB 130 and checks whether or not information about the phenomenon area selected for each image is stored in the phenomenon DB 130. It is assumed that the phenomenon DB 130 stores information about the phenomenon area selected in each of the images A-1, B-1, and C-1. In this case, the phenomenon area selection unit 103 acquires the information about the phenomenon area in each of the above images from the phenomenon DB 130. When information about the image D-1 is not stored in the phenomenon DB 130, the phenomenon area selection unit 103 selects a phenomenon area in the image D-1.

In this example embodiment, the phenomenon DB 130 stores information about the phenomenon area selected by the phenomenon area selection unit 103 and information about the position and the posture of the camera estimated by the camera posture estimation unit 102. When information is stored in the phenomenon DB 130, the camera posture estimation unit 102 and the phenomenon area selection unit 103 acquire the information from the phenomenon DB 130. In this case, the camera posture estimation unit 102 and the phenomenon area selection unit 103 can omit the estimation of the position and the posture of the camera and the selection of the phenomenon area for an image that has already been processed.

In this example embodiment, the camera posture estimation unit 102 may estimate a position and a posture of a camera for an unprocessed image. Further, the phenomenon area selection unit 103 may select a phenomenon area for an unprocessed image. By doing so, the processing load on the image processing apparatus 100 can be reduced.

In the present disclosure, the image processing apparatus 100 may be configured as a computer apparatus or a server apparatus. FIG. 11 shows an example of a configuration of a computer apparatus that may be used as the image processing apparatus 100. A computer apparatus 500 includes a processor 510 such as a Central Processing Unit (CPU), a storage unit 520, a Read Only Memory (ROM) 530, a Random Access Memory (RAM) 540, a communication interface (IF) 550, and a user interface 560.

The communication interface 550 is an interface for connecting the computer apparatus 500 to a communication network through wired communication means, wireless communication means, or the like. The user interface 560 includes, for example, a display unit such as a display. The user interface 560 also includes an input unit such as a keyboard, a mouse, and a touch panel.

The storage unit 520 is an auxiliary storage device capable of holding various types of data. The storage unit 520 does not necessarily have to be a part of the computer apparatus 500. The storage unit 520 may be an external storage device or a cloud storage connected to the computer apparatus 500 through a network.

The ROM 530 is a non-volatile storage device. For example, a semiconductor storage device such as a flash memory having a relatively small capacity is used for the ROM 530. A program executed by the CPU 510 may be stored in the storage unit 520 or the ROM 530. The storage unit 520 or the ROM 530 stores, for example, various types of programs for implementing the functions of the respective units in the image processing apparatus 100.

The above program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a RAM, a ROM, a flash memory, a solid-state drive (SSD) or other types of memory technologies, a compact disc (CD), a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The RAM 540 is a volatile storage device. Various types of semiconductor memory devices such as a Dynamic Random Access Memory (DRAM) or a Static Random Access Memory (SRAM) are used for the RAM 540. The RAM 540 may be used as an internal buffer that temporarily stores data and the like. The CPU 510 loads the program stored in the storage unit 520 or the ROM 530 into the RAM 540 and executes the loaded program. The CPU 510 executes the program, whereby the functions of the respective units in the image processing apparatus 100 may be implemented. The CPU 510 may include an internal buffer that can temporarily store data and the like.

Note that, in the present disclosure, the image processing apparatus 100 does not need to be configured as one apparatus. The image processing apparatus 100 may be configured using a plurality of apparatuses physically separated from each other. For example, the image processing apparatus 100 may be configured using a first apparatus which is portable and a second apparatus which is installed in an office or the like. The first apparatus includes at least the image input unit 101 (see FIG. 2). In this case, a user may carry the first apparatus to a site where a structure such as a bridge is located, and input the captured image into the first apparatus at the site.

The image processing apparatus, the image processing method, and the program according to the present disclosure can enable a user to easily determine whether there has been a change in regard to the phenomenon, such as a crack or damage, that has occurred in a structure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note 1

An image processing apparatus comprising:
a posture estimation unit configured to estimate a position and a posture of a camera when the camera has captured each of at least two images including phenomena the same as each other based on the at least two images and three-dimensional data of a structure;
an area selection unit configured to select an area of the phenomenon in each of the at least two images;
a three-dimensional position specification unit configured to specify a position of each of the phenomena in a coordinate system of the three-dimensional data based on the estimated position and posture of the camera and the area selected in each of the at least two images; and
a projection unit configured to generate a projection image by projecting three-dimensional data including the specified position of each of the phenomena and compositing the phenomena included in the images in such a manner that the phenomena for the images are distinguishable from each other.

### Supplementary Note 2

The image processing apparatus according to supplementary note 1, wherein the projection unit changes, for each of the phenomena in the projection image, at least one of transmittance to be set and a display color to be assigned.

### Supplementary Note 3

The image processing apparatus according to supplementary note 1 or 2, wherein the at least two images are captured at times different from each other.

### Supplementary Note 4

The image processing apparatus according to supplementary note 3, wherein the projection unit causes, in a state in which the positions of the phenomena are shifted, the images of the phenomena to overlap on each other in the projection image in a chronological order or in a reverse chronological order of the dates on which the images of the phenomena have been captured.

### Supplementary Note 5

The image processing apparatus according to any one of supplementary notes 1 to 4, wherein the projection unit determines a surface to which each of the phenomena belongs as a projection surface based on the specified position of each of the phenomena in the coordinate system of the three-dimensional data, and determines a projection range shown in the projection image in the determined projection surface.

### Supplementary Note 6

The image processing apparatus according to supplementary note 5, wherein the projection unit calculates a curvature of a surface that includes a predetermined range including the specified position of the each of the phenomena from a normal of each of data points of the three-dimensional data in the predetermined range, and determines, as the projection surface, a surface having a curvature equal to the calculated curvature in an area continuously formed with an area in the predetermined range in the three-dimensional data.

### Supplementary Note 7

The image processing apparatus according to supplementary note 5 or 6, wherein the projection unit determines, as the projection range, a range shown by a rectangle centered on a center of the specified position of each of the phenomena.

### Supplementary Note 8

The image processing apparatus according to any one of supplementary notes 1 to 7, wherein the projection unit displays a scale symbol in the projection image.

### Supplementary Note 9

The image processing apparatus according to any one of supplementary notes 1 to 8, further comprising a phenomenon database configured to store, for each of the phenomena, information for identifying an image including the phenomenon, information about the area of the phenomenon in the image, and information about the estimated position and posture of the camera, wherein
when the information about the position and the posture of the camera is stored in the phenomenon database, the posture estimation unit acquires the information about the position and the posture of the camera from the phenomenon database, and
when the information about the area of the phenomenon is stored in the phenomenon database, the area selection unit acquires the information about the area of the phenomenon from the phenomenon database.

### Supplementary Note 10

An image processing method comprising:
estimating a position and a posture of a camera when the camera has captured each of at least two images including phenomena the same as each other based on the at least two images and three-dimensional data of a structure;
selecting an area of the phenomenon in each of the at least two images;
specifying a position of each of the phenomena in a coordinate system of the three-dimensional data based on the estimated position and posture of the camera and the area selected in each of the at least two images; and
generating a projection image by projecting three-dimensional data including the specified position of each of the phenomena and compositing the phenomena included in the images in such a manner that the phenomena for the images are distinguishable from each other.

### Supplementary Note 11

A program for causing a computer to execute processing comprising: estimating a position and a posture of a camera when the camera has captured each of at least two images including phenomena the same as each other based on the at least two images and three-dimensional data of a structure;
selecting an area of the phenomenon in each of the at least two images;
specifying a position of each of the phenomena in a coordinate system of the three-dimensional data based on the estimated position and posture of the camera and the area selected in each of the at least two images; and
generating a projection image by projecting three-dimensional data including the specified position of each of the phenomena and compositing the phenomena included in the images in such a manner that the phenomena for the images are distinguishable from each other.

Some or all of elements (e.g., structures and functions) specified in supplementary notes 2 to 9 dependent on supplementary note 1 may also be dependent on supplementary notes 10 and 11 in dependency similar to that of supplementary notes 2 to 9 on supplementary note 1. Some or all of elements specified in any of supplementary notes may be applied to various types of hardware, software, and recording means for recording software, systems, and methods.

What is claimed is:

1. An image processing apparatus comprising:
at least one memory storing instructions; and
at least one processor configured to execute the instructions to:
estimate a position and a posture of a camera when the camera has captured each of at least two images including phenomena the same as each other based on the at least two images and three-dimensional data of a structure;
select an area of the phenomenon in each of the at least two images;
specify a position of each of the phenomena in a coordinate system of the three-dimensional data based on the estimated position and posture of the camera and the area selected in each of the at least two images; and
generate a projection image by projecting three-dimensional data including the specified position of each of the phenomena and compositing the phenomena included in the images in such a manner that the phenomena for the images are distinguishable from each other.

2. The image processing apparatus according to claim 1, wherein the at least one processor is configured to execute the instructions to change, for each of the phenomena in the projection image, at least one of transmittance to be set and a display color to be assigned.

3. The image processing apparatus according to claim 1, wherein the at least two images are captured at times different from each other.

4. The image processing apparatus according to claim 3, wherein the at least one processor is configured to execute the instructions to overlap, in a state in which the positions of the phenomena are shifted, the images of the phenomena on each other in the projection image in a chronological order or in a reverse chronological order of the dates on which the images of the phenomena have been captured.

5. The image processing apparatus according to claim 1, wherein the at least one processor is configured to execute the instructions to determine a surface to which each of the phenomena belongs as a projection surface based on the specified position of each of the phenomena in the coordinate system of the three-dimensional data, and determine a projection range shown in the projection image in the determined projection surface.

6. The image processing apparatus according to claim 5, wherein the at least one processor is configured to execute the instructions to calculate a curvature of a surface that includes a predetermined range including the specified position of the each of the phenomena from a normal of each of data points of the three-dimensional data in the predetermined range, and determine, as the projection surface, a surface having a curvature equal to the calculated curvature in an area continuously formed with an area in the predetermined range in the three-dimensional data.

7. The image processing apparatus according to claim 5, wherein the at least one processor is configured to execute the instructions to determine, as the projection range, a range shown by a rectangle centered on a center of the specified position of each of the phenomena.

8. The image processing apparatus according to claim 1, wherein the at least one processor is configured to execute the instructions to display a scale symbol in the projection image.

9. The image processing apparatus according to claim 1, further comprising a phenomenon database configured to store, for each of the phenomena, information for identifying an image including the phenomenon, information about the area of the phenomenon in the image, and information about the estimated position and posture of the camera,
wherein the at least one processor is configured to execute the instructions to:
when the information about the position and the posture of the camera is stored in the phenomenon database, acquire the information about the position and the posture of the camera from the phenomenon database; and
when the information about the area of the phenomenon is stored in the phenomenon database, acquire the information about the area of the phenomenon from the phenomenon database.

10. An image processing method comprising:
estimating a position and a posture of a camera when the camera has captured each of at least two images including phenomena the same as each other based on the at least two images and three-dimensional data of a structure;
selecting an area of the phenomenon in each of the at least two images;
specifying a position of each of the phenomena in a coordinate system of the three-dimensional data based on the estimated position and posture of the camera and the area selected in each of the at least two images; and
generating a projection image by projecting three-dimensional data including the specified position of each of the phenomena and compositing the phenomena included in the images in such a manner that the phenomena for the images are distinguishable from each other.

11. A non-transitory computer readable medium storing a program for causing a computer to execute processing comprising:
estimating a position and a posture of a camera when the camera has captured each of at least two images including phenomena the same as each other based on the at least two images and three-dimensional data of a structure;
selecting an area of the phenomenon in each of the at least two images;
specifying a position of each of the phenomena in a coordinate system of the three-dimensional data based on the estimated position and posture of the camera and the area selected in each of the at least two images; and
generating a projection image by projecting three-dimensional data including the specified position of each of the phenomena and compositing the phenomena included in the images in such a manner that the phenomena for the images are distinguishable from each other.
